(19) United States
(12) Patent Application Publication
(10) Pub. No.: US 2016/0305915 A1
(43) Pub. Date: Oct. 20, 2016

(54) SYSTEM FOR INSPECTING RAIL WITH PHASED ARRAY ULTRASONICS

(71) Applicant: Transportation Technology Center, Inc., Pueblo, CO (US)

(72) Inventors: Matthew Ward Witte, Tecumseh, MI (US); Semih Kalay, Colorado Springs, CO (US); Lucas Rahe Welander, Manzanola, CO (US); Paul Christopher Boulware, Columbus, OH (US); Roger Lynn Spencer, Ashville, OH (US)

(73) Assignee: Transportation Technology Center, Inc., Pueblo, CO (US)

(21) Appl. No.: 15/099,262

(22) Filed: Apr. 14, 2016

Related U.S. Application Data
(60) Provisional application No. 62/148,289, filed on Apr. 16, 2015.

(51) Int. Cl. G01N 29/265; G01N 29/24

(52) U.S. Cl. CPC G01N 29/265; G01N 29/24; G01N 2291/2623; G01N 2291/106

(57) ABSTRACT

A system for inspecting railroad rail using phased array ultrasonic technology includes both high-speed and high-resolution inspection modes that obviate the need for an operator to dismount the truck to perform detail inspection. In high-speed inspection mode, the phased array probes operate at fixed angles with respect to the rail to identify potential rail defects as the vehicle moves along the track. The vehicle can then return to the location of a potential rail defect and switch to a high-resolution inspection mode in which the phased array probes sweep over a range of beam angles at the location of a potential rail defect.

### RELATED APPLICATION

The present application is based on and claims priority to the Applicants' U.S. Provisional Patent Application 62/148,289, entitled “System for Inspecting Rail with Phased Array Ultrasonics,” filed on Apr. 16, 2015.

### BACKGROUND OF THE INVENTION

1. Field of the Invention

The present invention relates generally to the inspection of railway rail and more particularly to the inspection of in-situ railway rail from a moving vehicle on the track. More specifically, the present invention is in the field of phased array ultrasonic non-destructive evaluation.

2. Statement of the Problem

Ultrasonic nondestructive testing is a common inspection technology for detecting flaws in solid materials. Present-day ultrasonic systems for rail inspection consist of an inspection vehicle, at least one rolling search unit (RSU) per rail, multiple single-angle transducers, an ultrasonics controller and acquisition unit, and some means of processing, displaying, and storing the acquired data. The RSU is liquid-filled and pressurized so it can roll atop the rail head (as shown in FIGS. 1 and 2). It is linked to the inspection vehicle mechanically such that as the inspection vehicle moves, the RSU moves along with it. Single-angle transducers are mounted within the RSU at selected positions and orientations with respect to the rail.

Because defects in rail manifest themselves in different locations and orientations within the rail head, web, and base, traditional RSU configurations incorporate a multitude of single-angle ultrasonic transducers. Each transducer targets a different defect-prone location within the rail by being placed at a unique location within the RSU and utilizing a unique inspection angle. A typical inspection configuration may consist of multiple RSUs each with four to seven unique transducers.

The RSU rides on top of rail providing an interface for transmission of the ultrasonic energy into the rail. The ultrasonic energy is generated at the sensor interface within the RSU and emitted in a direction down towards the rail interface. The ultrasound transmits through the liquid in the RSU, the RSU membrane (typically polyurethane), through a thin liquid couplant that is applied ahead of the RSU, and into the rail. The ultrasound then reflects off of the rail geometry boundaries and returns to the receiving sensors. Inspection techniques are based on interrogation of the ultrasound signal as it returns to the sensor receptors (e.g., has the signal reflected off of any unexpected interfaces; cracks, pores, etc.).

In operation, each transducer fires at a given displacement interval along the track (e.g., every 0.125 in). The ultrasonic data for each interval is acquired and buffered into a live B-scan display depicting the data as a function of travel distance and sound path. The operator visually examines each of these B-scans and identifies any abnormal indications. Each indication is further classified as a specific ‘non-flaw’ or ‘flaw’ type.

The primary shortcoming of traditional ultrasonic rail inspection techniques is their inability to consistently diagnose faint indications (i.e., those indications which are smaller in size, or those indications which lie at abnormal orientation with respect to the inspection angle). Present-day systems operate in a single mode, high-speed inspection, which allows for inspection speeds up to 20 miles per hour or more. In this mode, operators must visually examine B-scans for abnormal signals or indications, and when observed, determine the type of indication. Is it a non-flaw indication, possibly from a bolt hole, a crossing, or a weld? Or is it a flaw indication such as transverse defect, a vertical split head, or a bolt-hole crack?

The inspection must be stopped to manually investigate when an indication cannot be reliably assigned by the operator. This may be due to the indication signal not being very strong or the indication signal resembling more than one indication type. Either way, the inspection vehicle is brought to a stop, and the operator must detrain to manually inspect the indication. This requires a significant amount of time as the manual equipment must be powered up, the indication location on the rail must be correlated to the B-scan depiction, and the manual inspection must be carried out (sometimes with multiple angles). Additionally, the data acquired during manual inspection is not consolidated with the high-speed data. It is simply used as a separate means of indication identification.

While these configurations have shown success in rail defect detection, they are limited in terms of adaptability and resolution. From the adaptability perspective, the configuration is fixed with respect to the rail. This means that they will not be sensitive to anomaly defects that do not reside in a typical defect zone or are oriented at atypical angles. If the defect is not in the inspection zone of the beam angle it will not be detected. If the defect manifests an abnormal orientation, the beam may not properly reflect off of the defect, and again, will not be detected. Additionally, if the rail profile conditions are not ideal (i.e., worn rail), the nominal angles may not be achieved. Defects that reside in typical zones may be missed when the fixed configuration angles have shifted because of the surface wear.

Traditional fixed angle configurations also evince deficiencies in resolution and redundancy with respect to defect detection. Depending on the size and orientation of the defect, only one angle may be able to detect it, and that detection may manifest itself in as few as one frame of data (e.g., A-scan). The operator may easily miss the indication. Additionally, a typical fixed angle configuration consists of incoherent angles, each inspecting a separate zone. Therefore, the links in data representation relating the indications between each angle are weak; a scan of angles across a defect is not possible and redundant detection of a defect is unlikely.

3. Solution to the Problem

The phased array technology employed in the present invention provides a means to address these deficiencies of traditional RSU configurations. In the present invention, a phased array ultrasonic probe is made up of multiple transducing elements built into an array (e.g., matrix, linear, annular, circular, etc.). These elements can be pulsed in such a way to focus, scan, or steer the ultrasonic beam. A phased array ultrasonic probe can be programmatically configured to produce variable beam angles. This means that when a faint indication is encountered and the indication assignment is not straightforward, the same phased array RSU can be reconfigured into a high-resolution mode for a more detailed inspection. In such a case, no detraining is required. The operator does not need to leave his seat to perform the detailed inspection. The ultrasonic probes are reconfigured to provide additional angles of inspection as the vehicle rolls back over the indication. The extra angles allow for investigation via sector scans focused on the expected location of the indication. This provides a detailed depiction of the indication, reliable assignment, and sizing of flaws. Because the high-resolution inspection is performed using the same equipment as the high-speed inspection, the inspection data and the indication assignment are easily consolidated with the standard data.

### SUMMARY OF THE INVENTION

The present invention addresses the deficiencies of traditional RSU configurations by providing phased array ultrasonic probes for inspecting railroad rail that allow for dual mode inspection in either a high-speed mode or a high-resolution mode. In particular, the phased array ultrasonic probes can be used either in fixed angle mode for high-speed inspection or in sweeping angle mode for high-resolution inspection. The system improves rail inspection efficiency by adding redundancy to the inspection and by obviating the need for an operator to dismount the truck to perform detail inspection

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a simplified system block diagram of the present inspection system carried by a railway vehicle 12 to inspect a rail 10.

FIG. 2 is a cross-sectional side view of the rail 10 and roller search unit (RSU) 20.

FIG. 3 is a pictorial diagram showing the preferred configuration of phased array probes showing three matrix phased array (MPA) probes 32-36 and one transverse linear phased array (LPA) probe 30.

FIG. 4 is a flowchart for data collection with a phased array ultrasonic probe.

FIG. 5 is a flowchart of the pulse and receive sequence for data collection in FIG. 4.

FIG. 6 is pictorial diagram representing the cross section of a rail head and indicating the approximate inspection coverage areas 60, 61, and 62 inspected by the probe configuration shown in FIG. 3.

FIG. 7 is a flowchart of the overall inspection system operation, including the ability to switch between high-speed and high-resolution modes of inspection.

FIG. 8 is a flowchart for the high-speed inspection mode.

FIG. 9 is a flowchart for the high-resolution inspection mode.

### DETAILED DESCRIPTION OF THE INVENTION

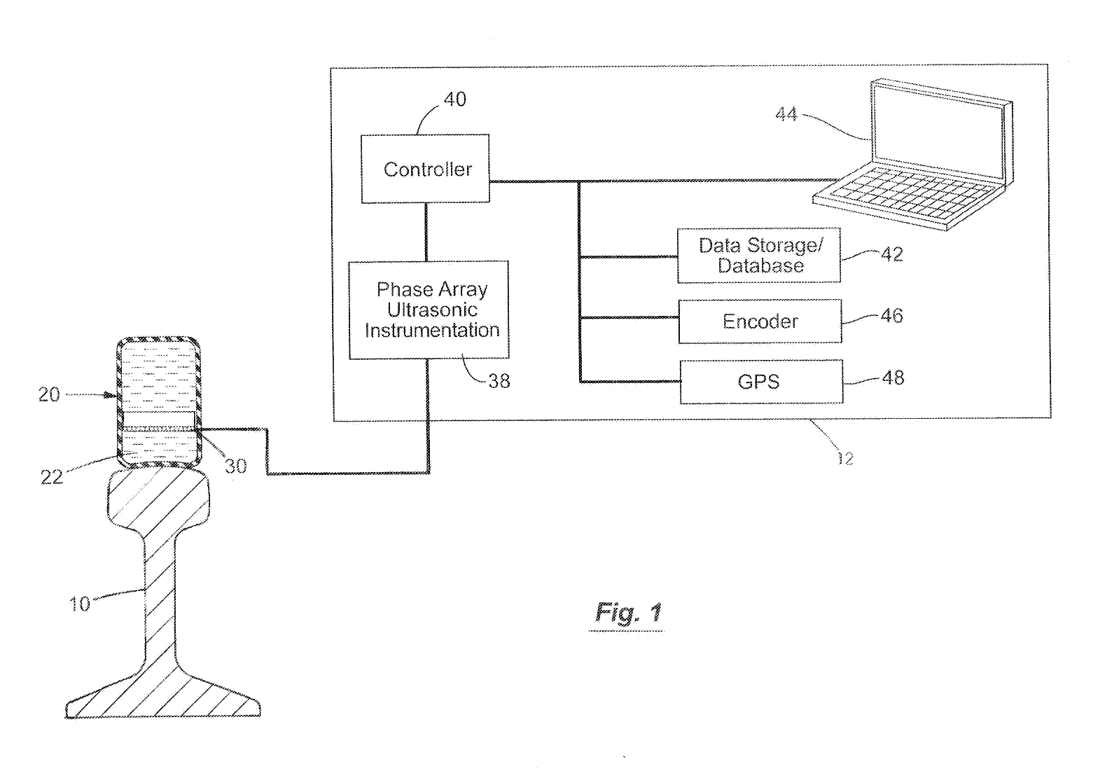

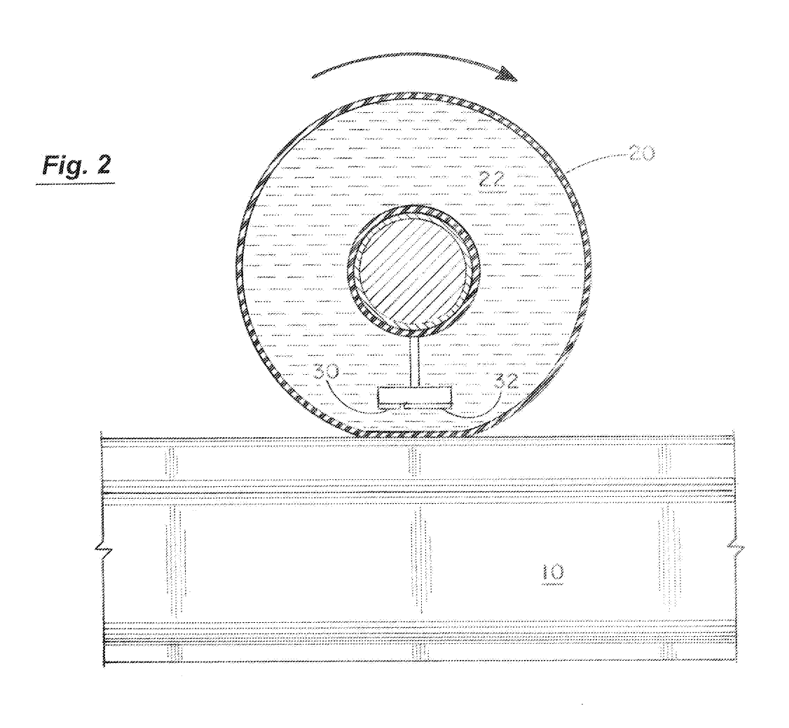

FIG. 1 is a simplified system block diagram of the present rail inspection system carried by a railway vehicle 12 to inspect a rail 10. The present ultrasonic rail inspection system is mounted on a suitable railway vehicle 12 to move along the rail 10 to be inspected. For example, a by-rail vehicle with a rear mounted carriage can be employed to carry the roller search unit (RSU) 20 containing a fluid 22. The test vehicle 12 and RSU 30 are used to guide a number of phased array ultrasonic probes 30-36 along the rail 10. FIG. 2 is a cross-sectional side view of the rail 10 and RSU 20. The test vehicle 12 can also be equipped with a couplant spray system that applies a thin layer of liquid couplant onto the rail head prior to contact with the RSU 20.

Each phased array ultrasonic probe 30-36 is configured to scan an ultrasonic beam with a variable beam angle toward a predetermined section of a rail and receive an ultrasonic return signal from the rail. The phased array ultrasonic probes 30-36 can be operated in parallel to simultaneously inspect distinct regions of the rail.

This inspection system also includes a controller 40 (e.g., computer processor) controlling operation of the phased array ultrasonic probes 30-36 via their ultrasonic instrumentation hardware 38. The controller 40 is equipped with data storage that can include a database 42 for storing information on indications of rail defects and their locations found during the inspection process.

The inspection system is also provided with a rail defect identification station for analysis of the ultrasonic return signals to identify indications of a potential rail defect. For example, this can be computer display 44 enabling an operator to view data generated by the controller from the return signals produced by the ultrasonic scans of the rail 10 and flag any indications of potential rail defects. Optionally, this process of identifying and flagging potential rail defects can be automated by a computer processor or other hardware to either supplement or replace visual inspection of the display 44 by a human operator.

Operation of the present system can be summarized as follows. The phased array ultrasonic probes 30-36 are initially operated in a high-speed mode at fixed beam angles with respect to the rail 10 to find indications of a potential rail defect as the vehicle 12 moves along the track. Data concerning these indications and their locations can be stored in a database 42 for future retrieval. The vehicle 12 is subsequently returned to the location of each potential rail defect for further detailed inspection in high-resolution mode. The phased array ultrasonic probes 30-36 are switched to operate in a high-resolution inspection mode with each phased array ultrasonic probe scanning over a range of beam angles at the location of the potential rail defect to enable high-resolution inspection. The resulting high-resolution inspection data can be integrated into the same database 42.

The present rail inspection system can include an encoder 46, GPS receiver 48 or odometer for tracking the location of the test vehicle 12 during inspection, so that indications or potential rail defects or other areas of interest identified during high-speed inspection can be accurately identified and revisited in the high-resolution inspection mode.

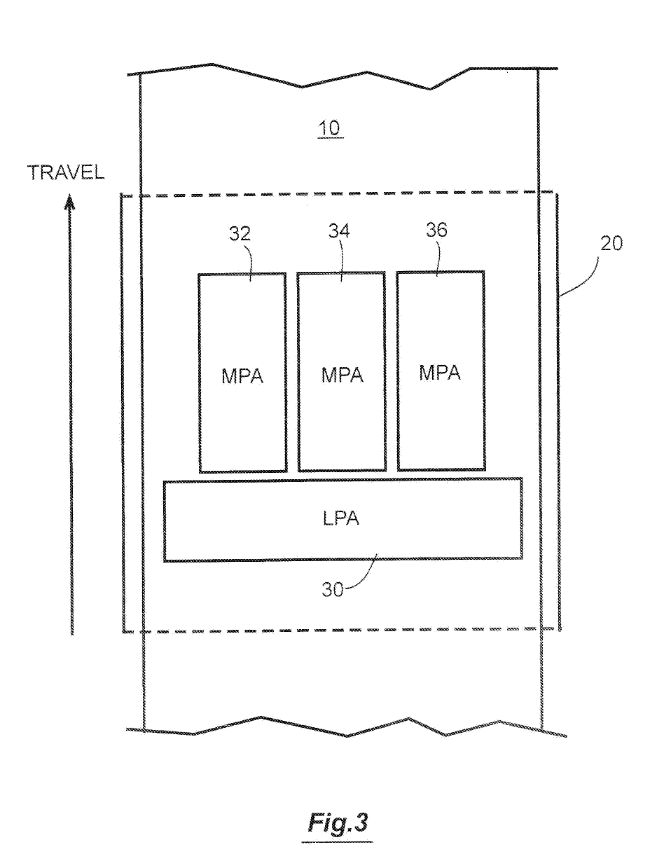

Probe Configuration. Each phased array ultrasonic probe 30-36 is made up of multiple transducing elements built into an array (matrix, linear, annular, circular, etc.). These elements are pulsed in such a way to focus, scan, and steer the ultrasonic beam toward a desired region of the rail 10 with a desired beam angle. A phased array probe can be programmatically configured to produce variable beam angles. The probe configuration can be a combination of linear and matrix phased array probes 30-36 within an RSU 20 as shown in FIG. 3. In this embodiment, the linear phased array (LPA) 30 is oriented transverse to the rail section. The three matrix phased arrays (MPA) 32, 34 and 36 are arranged side by side with their primary axes parallel to the rail 10. The matrix phased array probes 32-36 lead in the direction of travel in this embodiment. A set of focal law inspection angles are optimized for 20 mph inspection by configuring the MPA probes 32-36 to inspect laterally +/−20 degrees and longitudinally +/−60 degrees. This results in about 80% of the rail head being inspected by the matrix probes. The center matrix probe 34 can also inspect the rail web all the way to the base of the rail 10. The outer flanges of the base section of the rail 10 are not inspected in this configuration. The LPA probe 30 inspects to the web and the base of the rail 10, and also looks diagonally to the opposite corners of the rail head.

In practice, the design and selection of phased array ultrasonic probes 30-36 should be done on a case-by-case basis as the phased array probe count, location, array design, element count, element size, etc., needs to be optimized for each application. For rail inspection, this optimization is performed between (1) coverage of inspection, (2) speed of inspection, and (3) equipment cost. Virtual modeling of various combinations of probe counts, locations, arrays, elements, etc., was performed and one result is the configuration shown in FIG. 3. The overall configuration consists of four phased array probes-three matrix phased array (MPA) probes 32, 34 and 36 and one linear phased array probe (LPA) 30. The MPA probes 32-36 ride at the front of the RSU 20 relative to the direction of travel and consist of 125 elements each in a 25×5 matrix. In this embodiment, the LPA probe 30 rides at the rear of the RSU 20 and consists of 54 individual elements in a row along the secondary axis transverse to the rail.

The element counts designed into the probes balance rail geometry, resolution, and instrument limitations. For the MPA probes 32-26, a total of 125 elements arranged in a 25×5 configuration were chosen in this embodiment to maximize the number of elements without exceeding a 128 channel maximum for the instrument hardware 38. A five-element count was selected for the secondary axis to provide some means of steering and focusing. This leaves 25 elements for the primary axis for each MPA probe 32-36. For example, the MPA probes 32-36 can have an element size of about 0.6×1.7 mm, and an element pitch of about 0.8 and 2.0 mm.

The LPA probe 30 can push the limit of the physical boundaries by employing 54 elements out of an allowable 64 channels for the instrument hardware 38. Any more elements might exceed rail head width and the probe might be too long to fit within the RSU. For example, the LPA probe 30 can have an element size of about 0.8×10.0 mm, and an element pitch of about 1.0 mm.

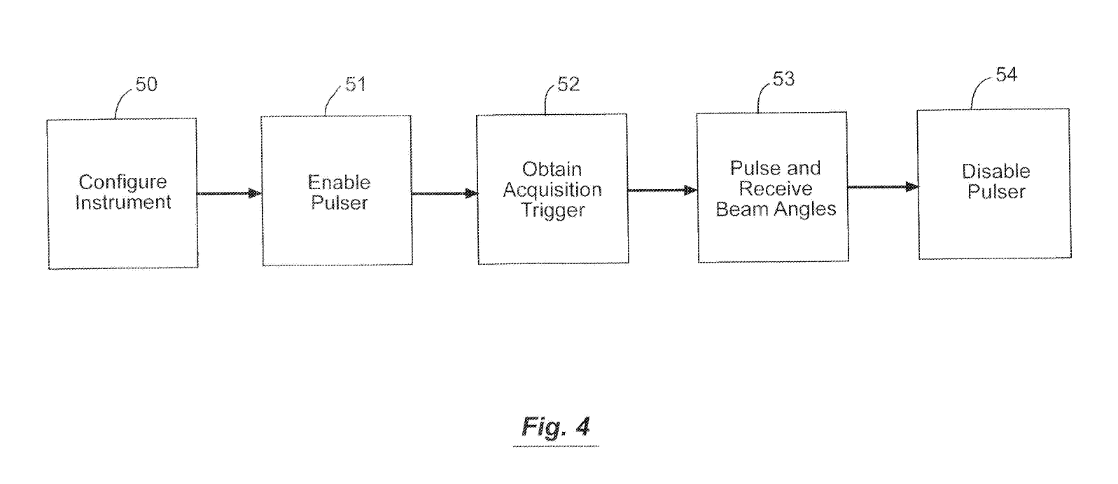

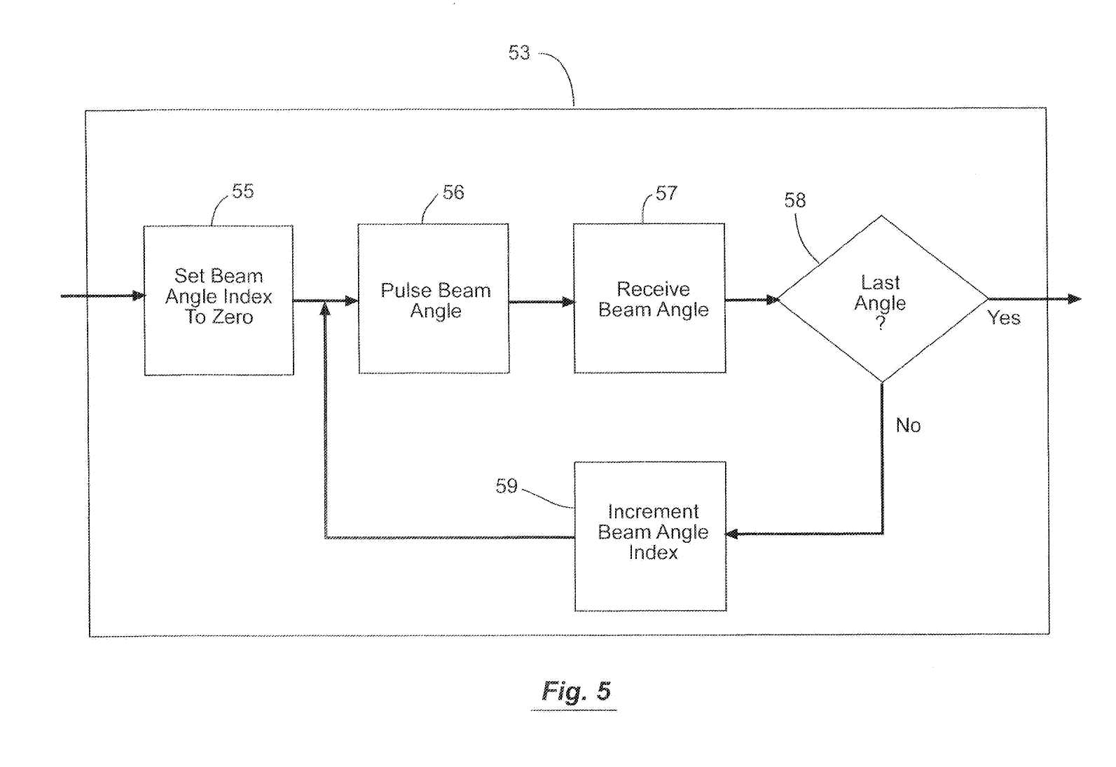

Furthermore, separating the total inspection elements into four probes 30-36 allows for speed enhancements as each probe can pulse, receive, and collect data simultaneously. In practice, each probe collects data as an independent unit following a sequence according to the flow chart illustrated in FIGS. 4 and 5.

The key aspect of the data collection flow chart is the serial nature of beam angle acquisitions. The instrument sequences, one-by-one, through each beam angle for every acquisition firing. This plays a role in limiting the maximum achievable inspection speed as each beam angle pulse-and-receive loop requires time to allow for the ultrasound energy to physically traverse into the rail, reflect, and travel back into the receiver. Each beam angle adds to overall cycle time for each acquisition. Separating these angles into disparate probes saves time because each probe only executes its own specific angles.

Beam Angles. Each of the phased array probes has its own inspection role and operates in parallel to inspect different portions of the rail 10. For example, the matrix probes 32-36 can be dedicated to rail head inspection. The linear probe 30 can be dedicated to full rail height inspection through the web and side-looking inspection within the rail head.

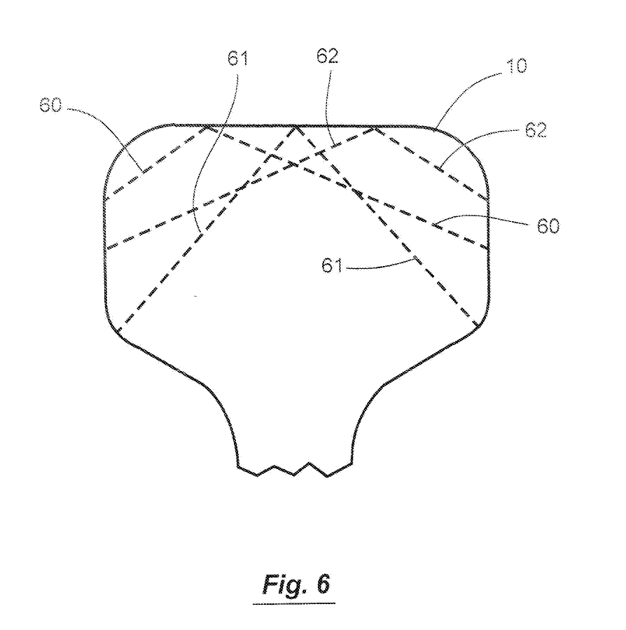

Beam angles can be selected based on a combination of modeling and inspection simulation results, as well as experimental scans on rail samples containing known flaws. Preferably, the number of beam angles is minimized to provide faster inspection speeds (e.g., a goal of 20 mph inspection vehicle speed) while maintaining inspection fidelity. The combination of beam angles provides inspection coverage similar to what is depicted in FIG. 6. The overlapping fields of view 60-62 provide inspection coverage of approximately 80% of the head area of the rail 10. Examples of the beam inspection angles are outlined below:

### Center MPA Nominal Angle Selections

| Primary Angle (°) | Secondary Angle (°) |
|---|---|
| 0 | 0 |
| 45 | 0 |
| −45 | 0 |
| 45 | 15 |
| 45 | −15 |
| −45 | 15 |
| −45 | −15 |

### Field MPA Nominal Angle Selections (Right Rail)

| Primary Angle (°) | Secondary Angle (°) |
|---|---|
| 45 | 0 |
| −45 | 0 |
| 45 | 15 |
| 45 | −15 |
| −45 | 15 |
| −45 | −15 |
| 60 | 20 |
| −60 | 20 |

### Gage MPA Nominal Angle Selections (Right Rail)

| Primary Angle (°) | Secondary Angle (°) |
|---|---|
| 45 | 0 |
| −45 | 0 |
| 45 | 15 |
| 45 | −15 |
| −45 | 15 |
| −45 | −15 |
| 60 | −20 |
| −60 | −20 |

### LPA Nominal Angle Selections

| Primary Angle (°) | Secondary Angle (°) |
|---|---|
| −48 | 0 |
| −34 | 0 |
| 34 | 0 |
| 48 | 0 |
| 0 | 0 |

In high-resolution mode, the beam angle set for the center MPA 34 can sweep between a primary angle of −45° to 45° in 2° increments with a secondary angle of 0°. Non-zero secondary angles are also possible.

It is important to note that while the role of each phased array probe 30-36 remains constant throughout high-speed inspection, the actual refracted beam angles can vary dependent on the degree of wear on the rails. The present system can also compensate for wear in the rail profile. Any of a variety of rail profiling systems can be employed to determine the degree of wear, such as ultrasonic, optical or mechanical sensing systems. It should be noted that the values listed in the tables above outline nominal values. If wear is detected, these values can be dynamically shifted to better cover the actual rail volume. In other words, a focal law compensation can be applied to the phased array focal law for the phased array ultrasonic probes to direct the inspection beams according to the measured wear angle. The separation of probes provides an advantage in this case as each set of beam angles may be adjusted independently. For example, if wear is only detected on the gage side, adjustments may be limited to only the LPA and gage side MPA probes.

Furthermore, the angles discussed above have been designed to be used in a high-speed inspection mode. Separating the total inspection into four probes allows for more elements to be included in each probe (up to the channel limitation per instrument), and allows for speed enhancements as each probe can pulse, receive, and collect data simultaneously.

In practice, each phased array ultrasonic probe 30-36 collects data as an independent unit following a sequence according to the flowchart illustrated in FIG. 4. Each probe 30-36 is initially configured by the controller 40 in step 50, and the pulser is enabled in step 51. Acquisition trigger parameters are obtained from the controller 40 in step 52. The probe 30-36 then scans through a specified range of beams angles using the pulse-and-receive cycle 53. Finally, the pulser is disabled in step 54.

FIG. 5 is a more detailed flowchart of the pulse-and-receive sequence 53 for data collection by each phased array ultrasonic probe 30-36 through a range of beam angles in FIG. 4. The beam angle index for the phased array ultrasonic probe 30-36 is initially set to zero in step 55. The phased array ultrasonic probe is then pulsed at that beam angle in step 56. The return signal for that beam angle is received in step 57. If the beam angle is not the last in the range of angles to the scanned (step 58), the beam angle index is incremented in step 59 and the process returns to step 56 in FIG. 5.

Dual Mode Configuration. The focus on reducing acquisition cycle time is crucial for high-speed inspection. However, the reconfigurable nature of the phased array beam angles permits a separate mode to be utilized for high-resolution rail inspection. This mode may be used for verifying the presence of faint defect indications or for sizing defects. The advantage is that these tasks can be accomplished programmatically. There is no need for the operator to leave the inspection vehicle 12 because there is no need to scan with a handheld device. In practice, the optimal inspection angle can be chosen for sizing the indication. Also, data from multiple angles can be graphically merged in a sector scan to image the defect.

Present-day systems operate under one mode of high-speed inspection. The operator must visually examine B-scans for abnormal signals or indications and when observed, determine the type of indication. The inspection must be stopped to manually investigate when an indication cannot be reliably assigned by the operator. The inspection vehicle is brought to a stop, and the operator must detrain to manually inspect the indication. This requires a significant amount of time as the manual equipment must be powered up, the indication location on the rail must be correlated to the B-scan depiction, and the manual inspection must be carried out.

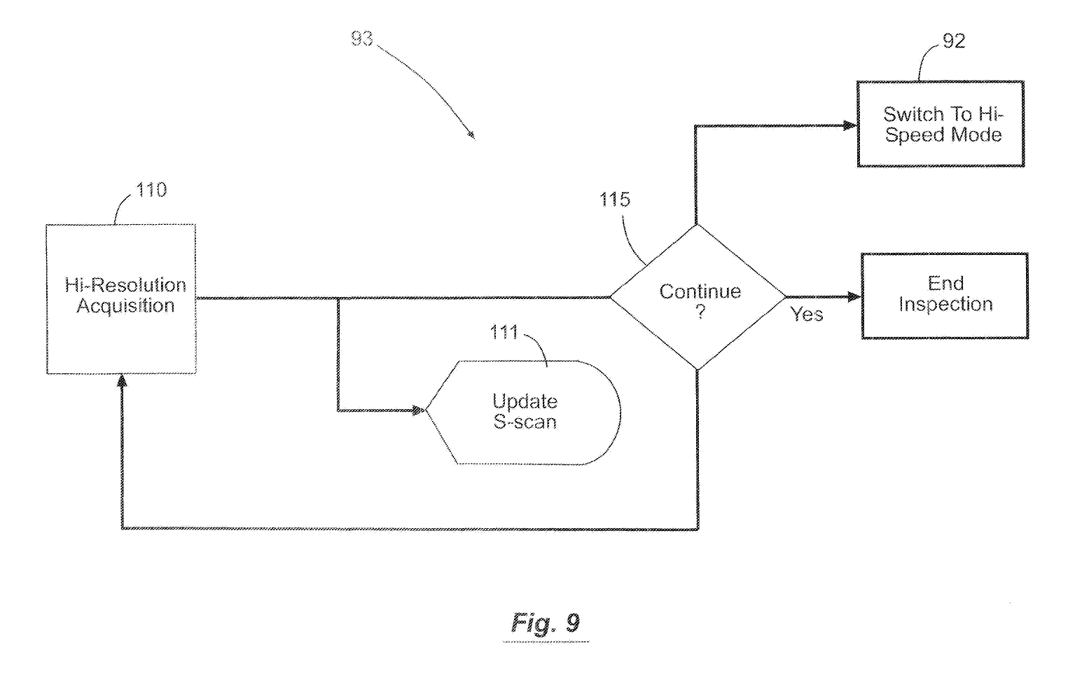

The present invention looks to address this deficiency through the application of phased array ultrasonics. A phased array probe is programmatically configured to produce variable beam angles. This means that when an initial indication of a potential rail defect is encountered in the high-speed inspection mode and the indication assignment is not straightforward, the phased array probes 30-36 within RSU 20 can be reconfigured into a high-resolution mode for a more detailed inspection. No detraining is required; the operator does not need to leave his seat. The phased array ultrasonic probes 30-36 are reconfigured to provide more angles of inspection as the vehicle rolls back over the indication. The extra angles allow for investigation via sector scans focused on the expected location of the indication. This provides a detailed depiction of the indication, reliable assignment, and sizing of flaws. The inspection data and the indication assignment are consolidated with the standard, high-speed mode data. FIG. 9 provides a flowchart for this high-resolution mode of operation.

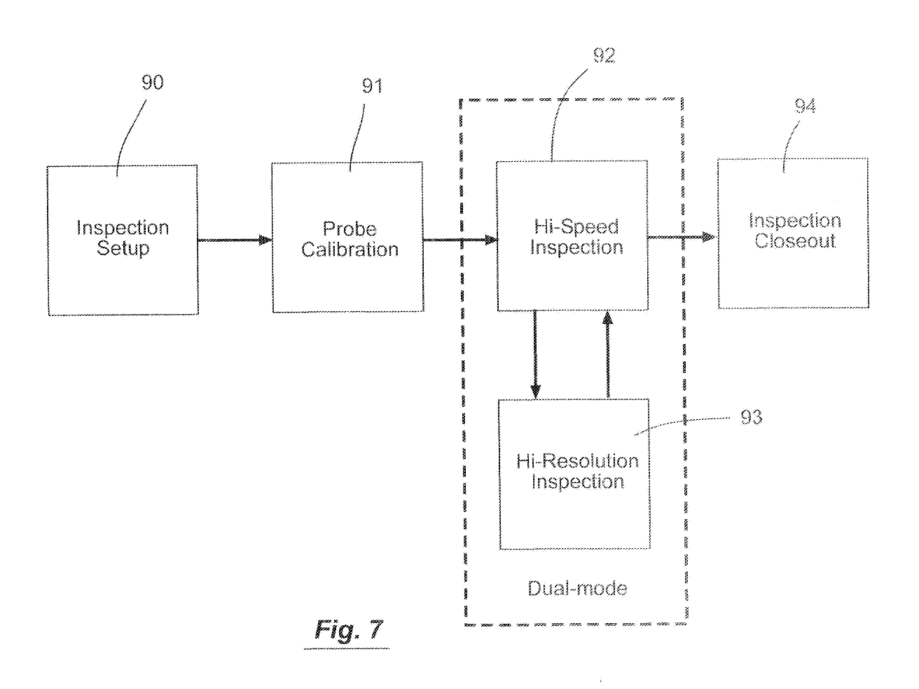

This methodology of dual-mode inspection allows greater confidence in inspection, better sizing capabilities for flaw size tracking over time, faster overall inspection speeds and safety advancements over present-day systems. Overall, the inspection methodology follows the flow chart in FIG. 7. Performing an inspection starts with initial setup and configuration of the system (step 90). This includes the ultrasonic settings (focal laws, ranges, gains, encoder resolution, etc.) for each probe and general inspection detail input (inspection name, rail type, unit preferences, etc.). The next step is to properly align the probes on the rails (step 91). This is done via ultrasonic feedback of the signals transmission capability through the rail. Finally, the inspection is initiated and placed into high-speed mode as a default (step 92).

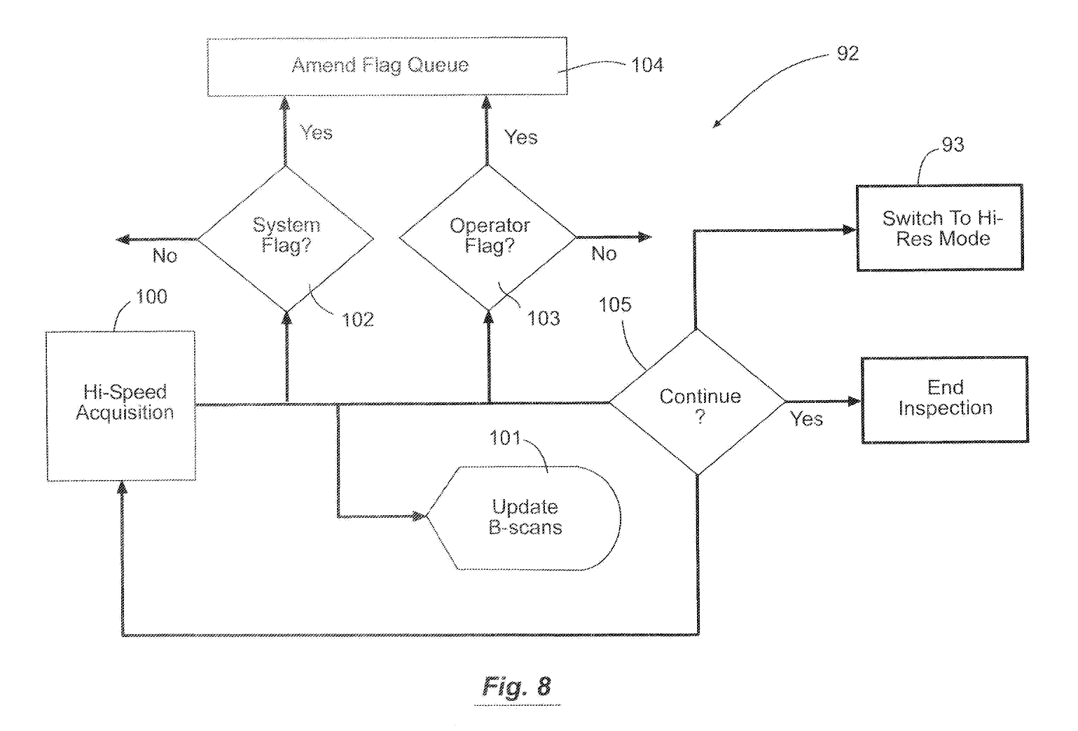

As the inspection progresses in FIG. 8, focal laws are fired at a given displacement interval (e.g. every 0.125 in). Inspection data is acquired (step 100) and buffered into live B-scan displays (step 101) depicting the data as a function of travel distance and sound path. In addition to the operator manually scrutinizing each of the B-scans for abnormal indications, each and every data array that builds up the B-scan set is programmatically checked for abnormal indications. Either the operator or the automated system can flag indications (steps 102 and 103).

Flagged indications, whether automatically flagged by the system or manually flagged by the operator, are queued (step 104) for the operator to provide an indication assignment. In cases where the flagged indication type is non-obvious, the operator can switch into a high-resolution mode (step 105 in FIG. 8 and step 93 in FIG. 7). This mode allows for an indication to be scanned with a highly augmented set of inspection angles, allowing for high-resolution sector scans of the indication.

In high-resolution mode beginning with step 110 in FIG. 9, the inspection vehicle 12 is brought to a stop and returns to the starting location of the unassigned indication. The phased array ultrasonic probes 30-36 are reconfigured by the controller 40 and phased array ultrasonic instrumentation 38 to allow for inspection angles which sweep across the rail 10 (typically at 1 or 2 degree increments). The inspection vehicle 12 then rolls directly over the unassigned indication capturing highly detailed sector scans (step 111) of the rail segment which includes the indication volume. The operator uses this detailed data to evaluate, assign, and possibly size the indication. The inspection mode is then switched back to high-speed mode (step 115 in FIG. 9 and step 92 in FIG. 7) and the inspection continues along the track (step 94 in FIG. 7). When the desired length of rail 10 is fully inspected and all indications are properly assigned, the inspection is ended and all inspection data is transferred to a database 42 for subsequent recall and analysis.

This dual-mode system with high-speed inspection can be optimized for a relatively high rate of travel along the rail 10 (e.g., 20 mph). The high-speed inspection mode generally uses fixed beam angles, but can compensate for rail head wear, as described above. In contrast, the high-resolution inspection mode is used for detailed characterization of flaws initially detected in the high-speed inspection mode. The high-resolution mode is activated from the on-board controls and can use the same phased array ultrasonic probes 30-36 and RSU 20 as the high-speed mode. In addition, data from the high-resolution mode can be integrated into the same database 42 as the high-speed inspection data.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A method for ultrasonic inspection of railway rails comprising:
providing a railway vehicle for moving along the railway;
providing a phased array ultrasonic probe on the vehicle, said phased array ultrasonic probe configured to controllably scan an ultrasonic beam with a variable beam angle toward a predetermined section of a rail and receive an ultrasonic return signal from the rail;
providing a rail defect identification station for analysis of the ultrasonic return signal to identify indications of a potential rail defect;
operating the phased array ultrasonic probe in a high-speed inspection mode at a fixed beam angle with respect to the rail to find an indication of a potential rail defect as the vehicle moves along the track;
returning the vehicle to the location of a potential rail defect; and
operating the phased array ultrasonic probe in a high-resolution inspection mode with the phased array ultrasonic probe scanning over a range of beam angles at the location of the potential rail defect to enable high-resolution inspection of the potential rail defect.

2. The method of claim 1 further comprising flagging indications of potential rail defects found in the high-speed inspection mode for subsequent high-resolution inspection.

3. The method of claim 2 further comprising maintaining a database of indications and their locations along the rail.

4. The method of claim 1 wherein indications of potential rail defects are identified by visual inspection of data generated from the ultrasonic return signal in the high-speed inspection mode.

5. The methods of claim 1 wherein indications of potential rail defects are identified by automated analysis of the ultrasonic return signal by a computer processor.

6. A method for ultrasonic inspection of railway rails comprising:
providing a railway vehicle for moving along the railway;
providing a plurality of phased arrays of ultrasonic probes on the vehicle, each phased array ultrasonic probe configured to controllably scan an ultrasonic beam with a variable beam angle toward a predetermined section of a rail and receive an ultrasonic return signal from the rail, said phased array ultrasonic probes simultaneously operating to inspect distinct regions of the rail;
providing a rail defect identification station for analysis of the ultrasonic return signals to identify indications of a potential rail defect;
operating the phased array ultrasonic probes in a high-speed inspection mode at fixed beam angles with respect to the rail to find an indication of a potential rail defect as the vehicle moves along the track;
returning the vehicle to the location of a potential rail defect; and
operating the phased array ultrasonic probes in a high-resolution inspection mode with the phased array ultrasonic probes scanning over a range of beam angles at the location of the potential rail defect to enable high-resolution inspection of the potential rail defect.

7. The method of claim 6 further comprising flagging indications of potential rail defects found in the high-speed inspection mode for subsequent high-resolution inspection.

8. The method of claim 7 further comprising maintaining a database of indications and their locations along the rail.

9. The method of claim 6 wherein indications of potential rail defects are identified by visual inspection of data generated from the ultrasonic return signals in the high-speed inspection mode.

10. The methods of claim 6 wherein indications of potential rail defects are identified by automated analysis of the ultrasonic return signals by a computer processor.

11. An ultrasonic inspection apparatus for railway rails comprising:
a railway vehicle for moving along the railway;
a plurality of phased arrays of ultrasonic probes on the vehicle, each phased array ultrasonic probe configured to controllably scan an ultrasonic beam with a variable beam angle toward a predetermined section of a rail and receive an ultrasonic return signal from the rail, said phased array ultrasonic probes simultaneously operating to inspect distinct regions of the rail;
a rail defect identification station for analysis of the ultrasonic return signals to identify indications of a potential rail defect;
a controller selectably operating the phased array ultrasonic probes in either:
(a) a high-speed inspection mode in which the phased array ultrasonic probes operate with fixed beam angles with respect to the rail as the vehicle moves along the track; or
(b) a high-resolution inspection mode wherein the phased array ultrasonic probes scan over a range of beam angles with respect to the rail to provide high-resolution inspection of a potential rail defect identified in the high-speed inspection mode.

12. The apparatus of claim 11 further comprising means for flagging indications of potential rail defects found in the high-speed inspection mode for subsequent high-resolution inspection.

13. The apparatus of claim 12 further comprising a database of indications and their locations along the rail.

14. The apparatus of claim 11 wherein the rail defect identification station further comprises a display of data generated from the ultrasonic return signals for visual inspection to flag indications of potential rail defects in the high-speed inspection mode.

15. The apparatus of claim 11 wherein rail defect identification station further comprises a computer processor analyzing the ultrasonic return signals and flagging indications of potential rail defects found in the high-speed inspection mode.
